(19) United States
(12) Patent Application Publication
(10) Pub. No.: US 2026/0123595 A1
(43) Pub. Date: May 7, 2026

(54) CLEANING STRUCTURE HAVING COLLECTING OPENING AND CAT LITTER BOX

(71) Applicant: SHENZHEN PETABOO TECHNOLOGY CO., LTD., SHENZHEN (CN)

(72) Inventor: BOCHAO XU, SHENZHEN (CN)

(21) Appl. No.: 19/368,198

(22) Filed: Oct. 24, 2025

(30) Foreign Application Priority Data
Nov. 5, 2024 (CN) 202422693799.9

(51) Int. Cl. A01K 1/01; B08B 1/16; B08B 1/20

(52) U.S. Cl. CPC A01K 1/011; B08B 1/165; B08B 1/20

(57) ABSTRACT

A cat litter box and a cleaning structure thereof having a collecting opening are provided. The cleaning structure includes a collecting opening and a door body. The collecting opening is configured to be disposed above a collecting cavity of the cat litter box. The door body is configured to open or close the collecting opening. A cleaning scraper strip is disposed above the door body. When the door body is opened, the cleaning scraper strip is configured to clean cat feces on the door body. When cat feces fall on the door body and when the door body is opened, the cleaning scraper strip scrapes the cat feces on the door body to the collecting opening, and the cat feces fall into the collecting cavity through the collecting opening, so as to achieve the cleaning of the door body and achieve collection of the cat feces.

### TECHNICAL FIELD

The present disclosure relates to a field of pet products, in particular to a cat litter box and a cleaning structure thereof having a collecting opening.

### BACKGROUND

Cat litter boxes are a new product that has emerged in recent years. The cat litter boxes are configured to hold cat litter for urination and defecation of cats. In the prior art, cat feces in a cat litter box are fallen into a collecting cavity through a collecting opening, thereby effectively collecting the cat feces. The cat litter box generally has a door at the collecting opening to enable the collecting opening to be closed or opened. However, when the cat feces fall onto the door, the cat feces may remain on the door, affecting the use of the cat litter box.

### SUMMARY

To solve defects in the prior art, the present disclosure provides a cat litter box and a cleaning structure thereof having a collecting opening.

The present disclosure provides a cleaning structure of a cat litter box. The cleaning structure comprises a collecting opening and a door body. The collecting opening is configured to be disposed above a collecting cavity of the cat litter box. The door body is configured to open or close the collecting opening. A cleaning scraper strip is disposed above the door body. When the door body is opened, the cleaning scraper strip is configured to clean cat feces on the door body.

The cleaning structure further comprises a driving mechanism. The door body comprises a first door and a second door. The first door is disposed on a first end of the collecting opening. The second door is disposed on a second end of the collecting opening. The cleaning scraper strip comprises a first scraper strip and a second scraper strip. The first scraper strip is disposed above the first door. The second scraper strip is disposed above the second door. The driving mechanism is configured to drive the first door and the second door to move toward each other to close the door body or to move away from each other to open the door body, so as to close or open the collecting opening.

The cleaning scraper strip further comprises connecting portions. A first connecting portion thereof is connected between a first end of the first scraper strip and a first end of the second scraper strip, and a second connecting portion thereof is connected between a second end of the first scraper strip and a second end of the second scraper strip, so as to form the cleaning scraper strip of a ring shape.

The cleaning structure further comprises a base shell. The base shell comprises a first mounting wall disposed above the door body. The first mounting wall defines a clamping groove. The cleaning scraper strip is clamped in the clamping groove.

The second door comprises a sealing strip facing the first door. When the first door and the second door are closed toward each other, the first door abuts against the sealing strip of the second door.

The second door comprises a plugging strip. The sealing strip defines a plugging groove, and the plugging strip is plugged into the plugging groove of the sealing strip, so that the sealing strip is mounted on the second door.

Fastening holes are defined in the plugging strip. The fastening holes penetrate through the plugging strip from top to bottom. Fastening blocks are disposed in the plugging groove. When the plugging strip is engaged with the plugging groove, the fastening blocks are respectively engaged with the fastening holes.

A second mounting wall extending upward from the collecting opening is disposed on the collecting opening. The second mounting wall is annular. A sealing ring is sleeved on an outer side of the second mounting wall of the collecting opening. A first abutting wall extending downward from the first door is disposed on the first door. A second abutting wall extending downward from the second door is disposed on the second door. When the first door and the second door are closed toward each other, the first abutting wall and the second abutting wall are enclosed to form an annular abutting wall. A shape of the annular abutting wall is matched with a shape of the second mounting wall. An inner side of the annular abutting wall abuts against the sealing ring.

The driving mechanism comprises a driving motor and a driving gear. The driving gear is disposed on an output end of the driving motor.

The first door comprises a first mounting plate extending from one side of the first door. A first rack is disposed on the first mounting plate. The second door comprises a second mounting plate extending from one side of the second door. A second rack is disposed on the second mounting plate. The first rack is engaged with the driving gear from an upper side of the driving gear. The second rack is engaged with the driving gear from a lower side of the driving gear.

The present disclosure further provides a cat litter box. The cat litter box comprises the cleaning structure described above.

By such configurations, when in use, since the cleaning scraper strip is disposed above the door body, when cat feces falls on the door body and when the door body is opened, the cleaning scraper strip scrapes the cat feces remaining on the door body to the collecting opening, and the cat feces scrapped by the cleaning scraper strip fall into the collecting cavity through the collecting opening, so as to achieve the cleaning of the door body and achieve collection of the cat feces. A structure of the cleaning structure is simple and easy to use.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

The present disclosure is further described below with reference to the accompanying drawings and embodiments.

FIG. 1 is a cross-sectional schematic diagram of a cat little box according to one embodiment of the present disclosure.

FIG. 2 is an enlarged schematic diagram of portion A shown in FIG. 2.

FIG. 3 is a schematic diagram of a cleaning structure according to one embodiment of the present disclosure.

FIG. 4 is another schematic diagram of the cleaning structure according to one embodiment of the present disclosure, where a base shell is removed and a first door and a second door are closed.

FIG. 5 is an enlarged schematic diagram of portion B shown in FIG. 2.

FIG. 6 is an enlarged schematic diagram of portion C shown in FIG. 2.

FIG. 7 is a schematic diagram of a cleaning scraper strip according to one embodiment of the present disclosure.

FIG. 8 is an enlarged schematic diagram of portion D shown in FIG. 2.

FIG. 9 is an exploded schematic diagram of a sealing strip according to one embodiment of the present disclosure.

FIG. 10 is an enlarged schematic diagram of portion E shown in FIG. 9.

FIG. 11 is a schematic diagram of the cleaning structure shown in FIG. 4, where the first door and the second door are opened.

FIG. 12 is an exploded schematic diagram of the cleaning structure shown in FIG. 4, where the first door is separated from the cleaning structure.

### DETAILED DESCRIPTION

### Embodiment 1

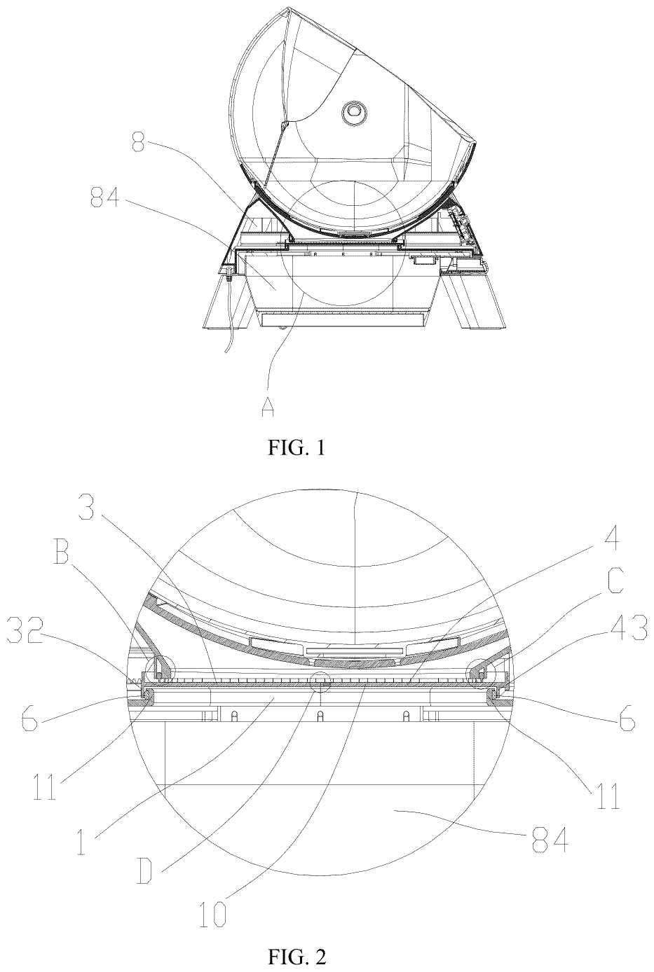

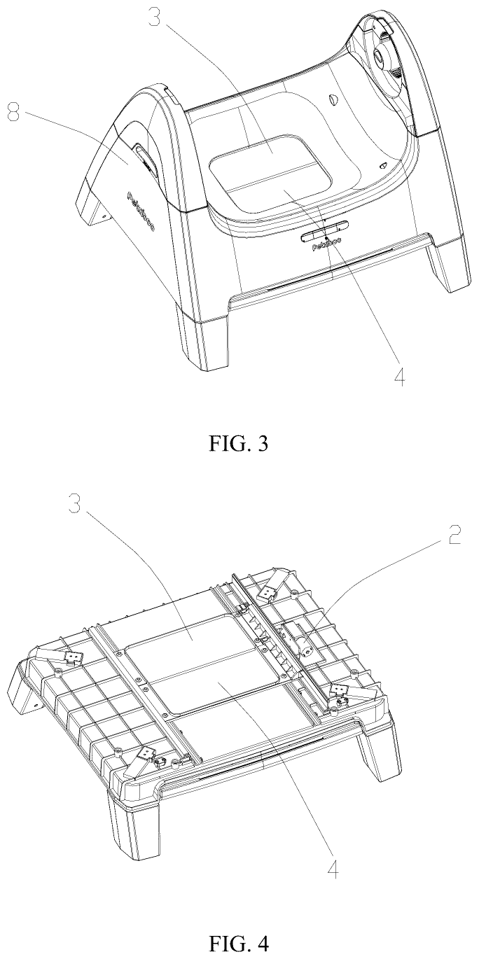

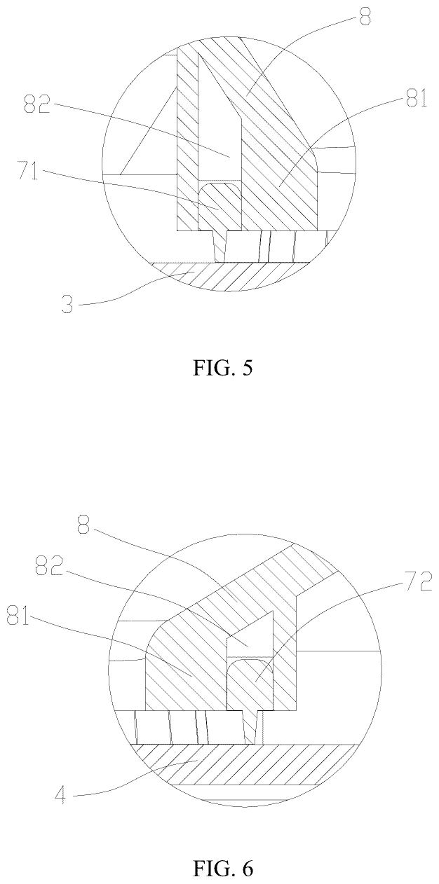

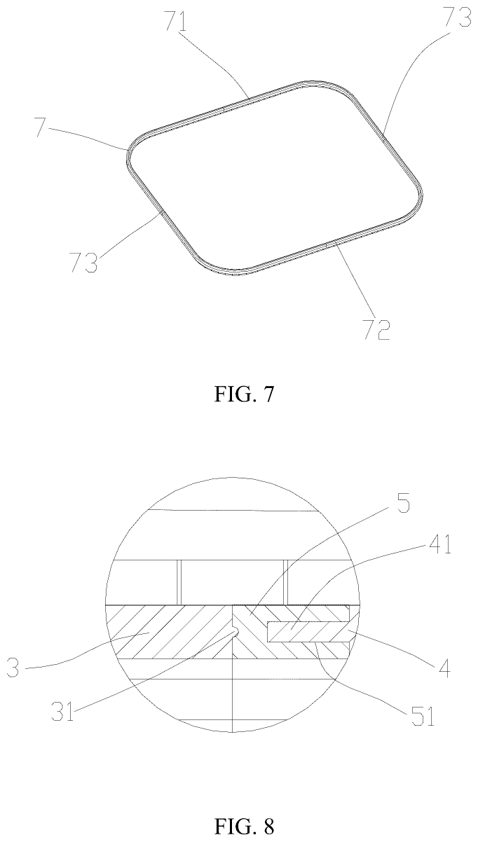

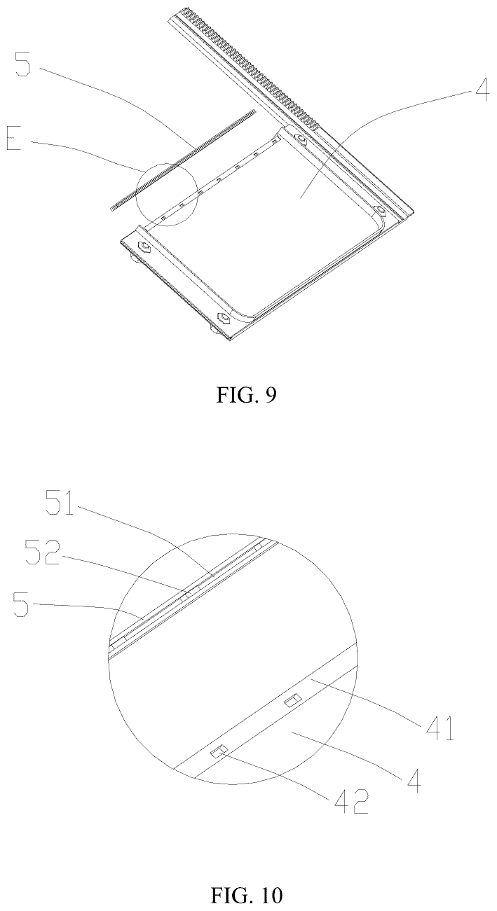

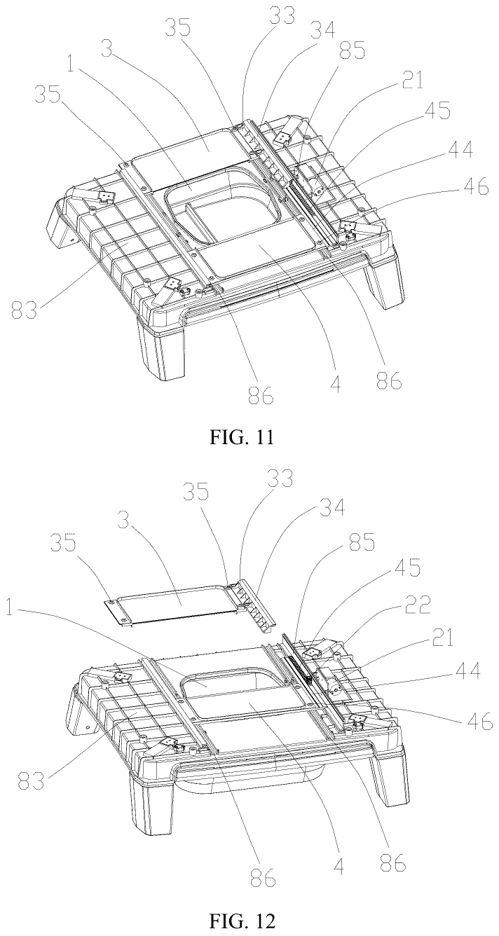

As shown in FIGS. 1-12, the present disclosure provides a cleaning structure of a cat litter box. The cleaning structure comprises a collecting opening 1 and a door body 10. The collecting opening 1 is configured to be disposed above a collecting cavity of the cat litter box. The door body 10 is configured to open or close the collecting opening 1. A cleaning scraper strip 7 is disposed above the door body 10. When the door body 10 is opened, the cleaning scraper strip 7 is configured to clean cat feces on the door body 10.

By such configurations, when in use, since the cleaning scraper strip 7 is disposed above the door body 10, when cat feces falls on the door body 10 and when the door body 10 is opened, the cleaning scraper strip 7 scrapes the cat feces remaining on the door body 10 to the collecting opening 1, and the cat feces scrapped by the cleaning scraper strip 7 fall into the collecting cavity through the collecting opening 1, so as to achieve the cleaning of the door body 10 and achieve collection of the cat feces. A structure of the cleaning structure is simple and easy to use.

The cleaning structure further comprises a driving mechanism 2. The door body 10 comprises a first door 3 and a second door 4. The first door 3 is disposed on a first end of the collecting opening 1. The second door 4 is disposed on a second end of the collecting opening 1. The cleaning scraper strip 7 comprises a first scraper strip 71 and a second scraper strip 72. The first scraper strip 71 is disposed above the first door 3. The second scraper strip 72 is disposed above the second door 4. The driving mechanism 2 is configured to drive the first door 3 and the second door 4 to move toward each other to close the door body or to move away from each other to open the door body, so as to close or open the collecting opening 1.

By such configurations, the first scraper strip 71 is able to clean the first door in a targeted manner, and the second scraper strip 72 is able to clean the second door in a targeted manner. The cleaning scraper strip 7 has a simple structure and a reasonable design. Furthermore, because the door body 10 is composed of the first door and the second door, a sliding stroke of the door body 10 is shorter than that of a single-piece door, meaning that a closing and opening time is shorter, which facilitates an operation of the cat litter box. Additionally, when the cat feces fall on the first door and the second door, since the cat feces generally fall into the collecting cavity from a middle of the collecting opening 1, when the first door and the second door are opened in opposite directions, the cat feces fall smoothly into the collecting cavity. The door body 10 has a simple structure and is easy to use. Closing the first door and the second door toward each other means that both the first door and the second door move toward the middle of the collecting opening to close the door body 10. Opening the first door and the second door in opposite directions means that both the first door and the second door move away from the middle of the collecting opening to open the door body 10. The first scraper strip 71 is attached to the first door, and the second scraper strip 72 is attached to the second door.

The cleaning scraper strip 7 further comprises connecting portions 73. A first connecting portion 73 thereof is connected between a first end of the first scraper strip 71 and a first end of the second scraper strip 72, and a second connecting portion 73 thereof is connected between a second end of the first scraper strip 71 and a second end of the second scraper strip 72, so as to form the cleaning scraper strip 7 of a ring shape. The cleaning scraper strip is an integrally formed structure, which facilitates an installation of the cleaning scraper strip.

Furthermore, the cleaning structure further comprises a base shell 8. The base shell 8 comprises a first mounting wall 81 disposed above the door body 10. The first mounting wall 81 defines a clamping groove 82. The cleaning scraper strip 7 of the ring shape is clamped in the clamping groove 82.

The second door 4 comprises a sealing strip 5 facing the first door 3. When the first door 3 and the second door 4 are closed toward each other, the first door 3 abuts against the sealing strip 5 of the second door 4 to achieve sealing of the first door 3 and the second door 4. The door body 10 has a simple structure and is stable and reliable.

The second door 4 comprises a plugging strip 41. The sealing strip 5 defines a plugging groove 51, and the plugging strip 41 is plugged into the plugging groove 51 of the sealing strip 5, so that the sealing strip 5 is mounted on the second door 4.

Furthermore, fastening holes 42 are defined in the plugging strip 41. The fastening holes 42 penetrate through the plugging strip 41 from top to bottom. Fastening blocks 52 are disposed in the plugging groove 51. When the plugging strip 41 is engaged with the plugging groove 51, the fastening blocks 52 are respectively engaged with the fastening holes 42. Therefore, an installation of the sealing strip 5 is more stable.

Furthermore, the first door 3 comprises a pressing strip 31 facing the second door 4. When the first door 3 and the second door 4 are closed toward each other, the pressing strip 31 of the first door 3 abuts against the sealing strip 5 of the second door 4, effectively improving a sealing effect between the first door and the second door.

In the embodiment, a second mounting wall 11 extending upward from the collecting opening 1 is disposed on the collecting opening 1. The second mounting wall 11 is annular. A sealing ring 6 is sleeved on an outer side of the second mounting wall 11 of the collecting opening 1. A first abutting wall 32 extending downward from the first door 3 is disposed on the first door 3. A second abutting wall 43 extending downward from the second door 4 is disposed on the second door 4. When the first door 3 and the second door 4 are closed toward each other, the first abutting wall 32 and the second abutting wall 43 are enclosed to form an annular abutting wall. A shape of the annular abutting wall is matched with a shape of the second mounting wall 11. An inner side of the annular abutting wall abuts against the sealing ring 6 to achieve effective sealing between the first door, the second door and the collecting opening, ensuring that liquid in the cat feces does not leak out, thereby protecting electronic components in the cat litter box. The structure of the cleaning structure is simple and the design thereof is reliable and reasonable.

The driving mechanism 2 comprises a driving motor 21 and a driving gear 22. The driving gear 22 is disposed on an output end of the driving motor 21. The first door 3 comprises a first mounting plate 33 extending from one side of the first door 3. A first rack 34 is disposed on the first mounting plate 33. The second door 4 comprises a second mounting plate 44 extending from one side of the second door 4. A second rack 45 is disposed on the second mounting plate 44. The first rack 34 is engaged with the driving gear 22 from an upper side of the driving gear 22. The second rack 45 is engaged with the driving gear 22 from a lower side of the driving gear 22. By such configurations, the driving motor, via the driving gear, drives the first rack disposed on the upper side of the driving gear and the second rack disposed on the lower side of the driving gear to move synchronously toward or away from each other. That is, the first door and the second door move synchronously toward or away from each other. The driving mechanism has a simple structure and a reasonable design.

A base plate 83 and the collecting cavity 84 are disposed on a bottom portion of the base shell. The collecting opening 1 is defined on the base plate 83, and the collecting cavity 84 is disposed below the collecting opening 1.

Specifically, a mounting bracket 85 is disposed on the base plate 83, the driving motor 21 is fixed to the mounting bracket 85. Guide rails 86 are disposed on the base plate 83. First sliders 35 are disposed on the first mounting plate 33, and second sliders 46 are disposed on the second mounting plate 4. The first slider 35 and the second slider 46 are disposed on the guide rails 86. In this way, when the driving motor drives the first door and the second door to move toward or away from each other, the first sliders and the second sliders slide along the guide rails, so that movements of the first door and the second door toward or away from each other are more stable.

### Embodiment 2

As shown in FIGS. 1-12, the present disclosure further provides a cat litter box. The cat litter box comprises the cleaning structure described above.

The cat litter box comprises the cleaning structure described above.

By the configurations of the cleaning structure, when in use, since the cleaning scraper strip 7 is disposed above the door body 10, when the cat feces falls on the door body 10 and when the door body 10 is opened, the cleaning scraper strip 7 scrapes the cat feces remaining on the door body 10 to the collecting opening 1, and the cat feces scrapped by the cleaning scraper strip 7 fall into the collecting cavity through the collecting opening 1, so as to achieve the cleaning of the door body 10 and achieve collection of the cat feces. A structure of the cleaning structure is simple and easy to use.

The above descriptions provide one or more embodiments in conjunction with the specific content, and specific implementations of the present disclosure are not limited thereto. Any similarity or similarity with the methods, structures, etc. of the present disclosure, or any technical deduction or substitution based on the concept of the present disclosure, shall be deemed to be within the protection scope of the present disclosure.

What is claimed is:

1. A cleaning structure of a cat litter box, comprising:
a collecting opening; and
a door body,
wherein the collecting opening is configured to be disposed above a collecting cavity of the cat litter box, the door body is configured to open or close the collecting opening, a cleaning scraper strip is disposed above the door body, and when the door body is opened, the cleaning scraper strip is configured to scrap the door body.

2. The cleaning structure according to claim 1, wherein the cleaning structure further comprises a driving mechanism, the door body comprises a first door and a second door, the first door is disposed on a first end of the collecting opening, and the second door is disposed on a second end of the collecting opening;
wherein the cleaning scraper strip comprises a first scraper strip and a second scraper strip, the first scraper strip is disposed above the first door, and the second scraper strip is disposed above the second door;
wherein the driving mechanism is configured to drive the first door and the second door to move toward each other to close the door body or to move away from each other to open the door body, so as to close or open the collecting opening.

3. The cleaning structure according to claim 2, wherein the cleaning scraper strip further comprises connecting portions, a first connecting portion thereof is connected between a first end of the first scraper strip and a first end of the second scraper strip, and a second connecting portion thereof is connected between a second end of the first scraper strip and a second end of the second scraper strip, so as to form the cleaning scraper strip of a ring shape.

4. The cleaning structure according to claim 3, wherein the cleaning structure further comprises a base shell, the base shell comprises a first mounting wall disposed above the door body, the first mounting wall defines a clamping groove, and the cleaning scraper strip is clamped in the clamping groove.

5. The cleaning structure according to claim 2, wherein the second door comprises a sealing strip facing the first door, and when the first door and the second door are closed toward each other, the first door abuts against the sealing strip of the second door.

6. The cleaning structure according to claim 5, wherein the second door comprises a plugging strip, the sealing strip defines a plugging groove, and the plugging strip is plugged into the plugging groove of the sealing strip, so that the sealing strip is mounted on the second door.

7. The cleaning structure according to claim 6, wherein fastening holes are defined in the plugging strip, the fastening holes penetrate through the plugging strip from top to bottom, fastening blocks are disposed in the plugging groove, and when the plugging strip is engaged with the plugging groove, the fastening blocks are respectively engaged with the fastening holes.

8. The cleaning structure according to claim 2, wherein a second mounting wall extending upward from the collecting opening is disposed on the collecting opening, the second mounting wall is annular, a sealing ring is sleeved on an outer side of the second mounting wall of the collecting opening, a first abutting wall extending downward from the first door is disposed on the first door, and a second abutting wall extending downward from the second door is disposed on the second door;
wherein when the first door and the second door are closed toward each other, the first abutting wall and the second abutting wall are enclosed to form an annular abutting wall;
wherein a shape of the annular abutting wall is matched with a shape of the second mounting wall, and an inner side of the annular abutting wall abuts against the sealing ring.

9. The cleaning structure according to claim 2, wherein the driving mechanism comprises a driving motor and a driving gear, and the driving gear is disposed on an output end of the driving motor;
wherein the first door comprises a first mounting plate extending from one side of the first door, a first rack is disposed on the first mounting plate, the second door comprises a second mounting plate extending from one side of the second door, a second rack is disposed on the second mounting plate, the first rack is engaged with the driving gear from an upper side of the driving gear, and the second rack is engaged with the driving gear from a lower side of the driving gear.

10. A cat litter box, comprising: the cleaning structure according to claim 1.
